(19) United States
(12) Patent Application Publication
(10) Pub. No.: US 2008/0072843 A1
(43) Pub. Date: Mar. 27, 2008

(54) Access device for pets

(75) Inventors: Enrico Malacarne, Dubendorf (CH); Aydin Arrigo, Porza (CH); Monica Emmenegger, Morcote (CH)

Correspondence Address: George Pappas, Suite 300, 919 S. Harrison Street, Fort Wayne, IN, 46802, US

(73) Assignee: Datamars SA

(21) Appl. No.: 11/903,107

(22) Filed: Sep. 20, 2007

(30) Foreign Application Priority Data
Sep. 22, 2006 (EP) EP 06 019 925.4

(51) Int. Cl. A01K 29/00

(52) U.S. Cl. 119/719; 119/712; 119/720

(57) ABSTRACT

In order to provide for a simple identification of admitted pets in an access device (2) for pets, particularly for dogs and cats, wherein the releasing and locking of the door (4) can be controlled by means of an electronic device (8), it is proposed to configure the electronic device (8) in such manner that any radio frequency controlled identification devices (RFID) located in proximity to a reader device can be included into the accession list by an input to a simple switching device (12).

### TECHNICAL FIELD

The present invention relates to an access device for pets, particularly for dogs and cats, according to the preamble of claim 1. By access device in this context are meant, in particular, access devices having doors of a type through which the pets can transit. In principle, however, this term shall also include access devices through which the pets can reach appropriate installations or spatially delimited zones e.g. for food uptake.

### PRIOR ART

Special access devices for pets, particularly for dogs and cats have existed for a long time. These satisfy the need to enable such animal to have independent access to the living zone of an apartment or a house without the need for direct assistance by a person. Such access devices usually comprise a pivotable flap with an upper suspension or a swinging door.

However, a problem with such access devices is that wild animals, animals that turned wild but also extraneous animals and even predators such as foxes etc. can obtain access. This shall be avoided. Several solutions for this have been suggested in the available art, but all of these appear to have drawbacks.

US-A-2004/0163316 just discloses a lockable pet door that has all the features that are needed mechanically but that does not support the identification of admissible pets and discrimination of other animals.

From US-A-2003/0204996 is known an access control wherein a trapdoor is opened by a remote controller. The mechanical arrangement of the trapdoor is rather disadvantageous. An individual access control without intervention of an operator is not contemplated in US-A-2003/0204996. The only possibility to keep out extraneous pets is provided by a timer control which locks again the door automatically after an access.

From US-A-2002/0011217 is known a pet door with which the pet shall wear a collar that will automatically activate a reed switch and shall open a flap door. This does not provide for an individual access control. Wild animals not wearing such a collar could indeed be kept out. However, an access is possible for any animals wearing a corresponding collar with a magnet that can activate the reed switch. A similar collar solution is known from U.S. Pat. No. 5,872,516, in which a communication by ultrasound is suggested.

U.S. Pat. No. 5,992,096 proposes a solution with a flap door, according to which a collar detector sends back an individual signal upon query from a reader unit, whereupon the flap mechanism is opened—by taking into account the signal of a movement detector. A similar access door—albeit without a movement sensor—is known from U.S. Pat. No. 6,141,911, which also relies on a temporarily limited opening of the door. In contrast, according to U.S. Pat. No. 6,297,739 B1 an identification sensor is further coupled to a weight sensor so that with the two sensors an unwanted access by non-authorized pets is made difficult.

On the other hand, US-A-2004/0113796 discloses a sliding door that also works with an RFID identification sensor but is preferably intended to be subsequently mounted in a window.

These devices may be suitable for the access of a specific individual animal. However, the problem remains that the individualized access doors need to be programmed in such manner that access is allowed to a single animal but not to other animals—be they extraneous pets, animals that turned wild or even wild animals. It is conceivable that on the factory level an identification transmitter is assigned to a very specific identification carrier, that is, e.g., to a collar. However, this solution appears to have little flexibility. Finally, if access shall be provided to a plurality of animals, all the systems known from the art described above reach their limits.

In the meantime, it is usual e.g. in case of a veterinary treatment but also for legal reasons to implant an RFID transponder to all the pets of a given kind. It would thus be desirable if an RFID transponder that has already been implanted in a pet for other reasons or possibly just for the purpose of access control could also be used for an access control. Of course, it would be possible to equip the access door with an input device for inputting an acceptable code, e.g. a multi-digit number or a bar code. However, it would be a substantial effort if an access device for pets had to be equipped with such an input device.

### DESCRIPTION OF THE INVENTION

It is an object of the invention to provide an access device with individualized access for pets, particularly for cats, that gives access to an individual animal or to a plurality of animals without the need of a complex device for inputting the code of a transponder that is implanted in the animal or attached to the animal.

The object of the invention is attained by an access device according to claim 1. The provisions of the invention readily lead to the result that access and exit through the door is made possible individually for the selected pet or for a group of pets, whereas the door remains locked otherwise. Additional access to one or several pets can be provided without the need for manual input of any data. Also, there is no need for additional equipment.

Advantageous embodiments are defined in claims 2 to 6.

The invention may be used advantageously if the reader device for transponders in the neighborhood does not need to be constantly in operation in order to search the neighborhood for pets, but rather if the electronic device is in a partly active standby mode. By means of a touch sensor or an approaching sensor that may be configured as a simple switch at the door but also as a movement sensor like in U.S. Pat. No. 6,297,739 B1, the transponder operation becomes activated so as to establish whether the previously detected contact of the door-flap was triggered by an admitted pet (claim 2). Particularly in this case, an operation with a non rechargeable battery or a rechargeable battery is possible (claim 3).

In special cases it may be advantageous if the door is open in one direction independently of the electronic identification, e.g. to allow an animal to leave a protected region anytime and independently of the identified transponder. In other cases, it can be advantageous if the door is closed in one direction independently of the electronic identification, e.g. to allow keeping an animal locked in after its return (claim 4). Furthermore, it can be advantageous to allow leaving a protected region anytime and independently of the identified transponder.

Also advantageous is a manual lock that will function independently of the identified transponder to either lock the door firmly (claim 5) or keep the same permanently open (claim 6), so as to be preventive regarding e.g. a possible power failure upon which the animal would be unintentionally locked in.

The embodiment as pet bell, according to which an admitted passage is signaled by a signal tone, is advantageous. This function can also be achieved optically, preferably by means of a light signal (claims 7 and 8). The connection between the door and the signaling device can be configured conventionally as a cable, but also as a transmitting device.

According to claim 9 it is contemplated that in case of a power failure the locking mechanism may be selectively overwritten by a release in one direction, preferably to enable leaving the inner region, or in both directions. This allows one to ensure that in case of a power failure the animal does not stay locked in and, as the case may be, that it has access to e.g. food. However, it is also possible to have the door completely locked, e.g. if there is no pet and thus the access mechanism shall stay closed.

The previously mentioned elements, as well as those claimed and described in the following working examples, which shall be used according to the present invention, are not subject to any specific exceptions in respect of their size, shape, material use and technical conception, so that the selection criteria known in the respective application fields can be applied without limitation.

### BRIEF DESCRIPTION OF THE DRAWINGS

Further details, advantages and features of the object of the present invention follow from the following description of the associated drawings which serve to explain—in the form of working examples—the doors according to the present invention. The drawings show:

FIG. 1 a representation of an access device from the front side according to a working example of the present invention;

FIG. 2 the installation of the access device according to FIG. 1 in a wall with a thickness of 5 mm;

FIG. 3 the installation of the access device according to FIG. 1 in a wall with a thickness of 40 mm; and

FIG. 4 the installation of the access device according to FIG. 1 in a wall with a thickness of 300 mm.

### MODES FOR CARRYING OUT THE INVENTION

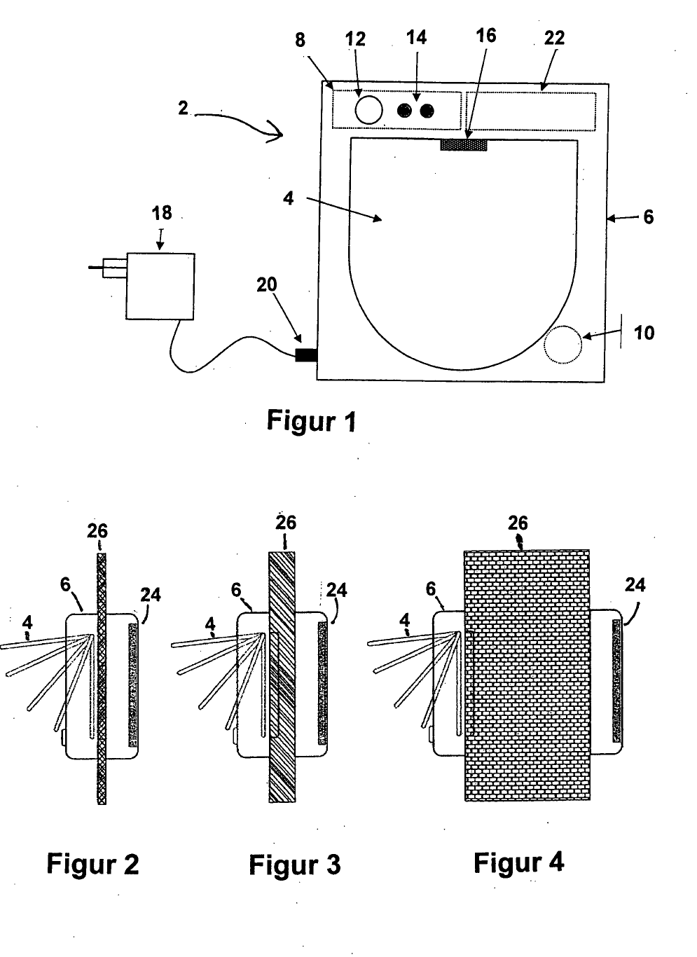

The access device for pets denoted by 2 as a whole in FIG. 1 in this working example has a constitution which is particularly useful for cats, but also for dogs and other pets such as e.g. rabbits, turtles, guinea pigs etc., and it can be installed into a wall but also in a normal door, a window, etc.

The access device has a door constituted by a flap 4 hanging at a horizontally disposed hinge, which flap is fixed to a frame 6 through the hinge. The flap is arranged in such manner as to be flippable upwards to both sides, thereby providing access. An electronic board 8 arranged in the frame 6 primarily controls the locking system 10. However, the latter can also be controlled manually by keeping the flap constantly locked or constantly open. It is possible to have the constantly open or locked state for one direction. In the present working example, the locking mechanism 10 exhibits a turn knob that in its various positions allows or requires an electrical release. On the access device this is subsequently displayed on display 14, which in the working example consists of two LEDs.

In the working example, the electronic board is supplied with electric power from a rechargeable battery, the rechargeable battery 22 being charged by means of an external power supply 18. The power supply is connected with the access device by means of plug 20.

It is important for the invention that the electronic board 8 comprises a reader device for transponders that reads out the code from a transponder chip located in the vicinity of the reader unit and compares the code with a list stored in electronic board 8. Alternatively, the reader unit can also be arranged separate from the electronic board, e.g. if required by spatial constraints. The reader unit is connected with an antenna device 24 that communicates with the transponder. Advantageously, the transponder will be implanted in a pet, but it is also possible to carry the transponder e.g. on a collar or attach the same to an ear.

Initially, the list stored on the electronic board 8 is empty, i.e. no access admission has been granted to any pets as initial setting. In order to grant admission to a pet having a corresponding, so far unknown transponder, the pet can be placed in the influence range of the antenna. By actuating the simple switch 12 designed as a push-button, the transponder code of the transponder arranged at or within the pet is read in and added to the list of admitted pets. The entry is confirmed with a signal of display 14 (blinking). In a next approach of this pet, upon comparison with the stored list this particular pet will be recognized and admitted according to the preset permissions (unidirectional or bidirectional admission). Hence, the locking mechanism 10 will be opened insofar as its turn-knob is set to allow for an electrical opening.

However, according to the present working example, in case of a power failure the locking mechanism can be overwritten by a release at least in the outbound direction, optionally also in the inbound direction, so that the pet is not permanently trapped in case of power failure.

In the present working example, the access device 2 further comprises an approach sensor 16. This is because for reasons of saving electrical power the reader device shall remain inactive until the approach sensor 16 detects an object in its proximity. Only then will the electronic circuitry be switched on and the process of reading and comparing the read in transponder code with the list be carried out and a decision be reached concerning the admission of the pet carrying the transponder. Alternatively, instead of the approach sensor 16, a touch sensor can be built into the flap of the access device then requiring that the animal tries to pass through the door, and only thereafter triggering the reading process by this touch sensor. However, the function is the same.

As shown in FIGS. 2 to 4, the access device can be installed in walls of very different thickness from less than 5 mm up to more than 30 mm, because antenna 24 is always arranged at the outside and the flap itself does not shield the radio waves of the reader device.

### LIST OF REFERENCE NUMERALS

2 access device
4 door
6 frame
8 electronic board
10 locking system
12 push-button for admission
14 indicators for the locked state
16 touch sensor
18 power supply
20 plug
22 rechargeable battery
24 antenna
26 wall

1. An access device for pets, particularly for dogs and cats, through which the pets can transit or reach appropriate installations or spatially delimited zones, comprising a frame and a door pivotally arranged in the frame, further comprising a device, by means of which the door is lockable to the frame, an electronic device with a data storage unit for controlling the releasing and locking of the door to the frame, a power supply device for said electronic device, with a reader device for radio frequency controlled identification devices (RFID) that is connected to or is a part of said electronic device and that comprises an antenna device for communication with one or a plurality of radio frequency controlled identification devices (RFID), a switching device for controlling said electronic device, wherein said electronic device is configured in such manner that the door at frame is released from a locked state when a radio frequency controlled identification device (RFID) is located in proximity of the reader device, wherein a release is effected only by such radio frequency controlled identification devices that exhibit an identification code that matches a corresponding identification code contained in a list stored in the data storage unit, and wherein the electronic device is configured in such manner that any radio frequency controlled identification devices (RFID) located in proximity to said reader device may be included in the list by an input to said switching device.

2. Access device according to claim 1, characterized in that it further comprises a contact or approach sensor and that it is configured to be in an idle or power saving partly active mode until the contact or approach sensor provides a signal.

3. Access device according to claim 1, characterized in that said power supply device is based on an operation with a non-rechargeable battery or with a rechargeable battery.

4. Access device according to claim 1, characterized in that a release of the door from the frame by radio frequency controlled identification devices, commanded by a manual actuation device, is only effected in one direction whereas in the other direction the door is set to be locked to or released from the frame.

5. Access device according to claim 1, characterized in that the door is lockable to the frame by means of a manual actuation device independently of said electronic device.

6. Access device according to claim 1, characterized in that the door is releasable from the frame by means of a manual actuation device independently of said electronic device.

7. Access device according to claim 1, characterized by an acoustic signaling device that signals the admitted passage by a signaling tone.

8. Access device according to claim 1, characterized by an optical signaling device that signals the admitted passage by an optical signal, preferably a light signal.

9. Access device according to claim 1, characterized in that the locking device in case of a power failure can be overwritten to a release mode optionally in one direction or in both directions.

10. Access device according to claim 2, characterized in that said power supply device is based on an operation with a non-rechargeable battery or with a rechargeable battery.

11. Access device according to claim 10, characterized in that a release of the door from the frame by radio frequency controlled identification devices, commanded by a manual actuation device, is only effected in one direction whereas in the other direction the door is set to be locked to or released from the frame.

12. Access device according to claim 11, characterized in that the door is lockable to the frame by means of a manual actuation device independently of said electronic device.

13. Access device according to claim 12, characterized in that the door is releasable from the frame by means of a manual actuation device independently of said electronic device.

14. Access device according to claim 13, characterized by an acoustic signaling device that signals the admitted passage by a signaling tone.

15. Access device according to claim 14, characterized by an optical signaling device that signals the admitted passage by an optical signal, preferably a light signal.

16. Access device according to claim 15, characterized in that the locking device in case of a power failure can be overwritten to a release mode optionally in one direction or in both directions.

17. Access device according to claim 2, characterized in that the door is lockable to the frame by means of a manual actuation device independently of said electronic device.

18. Access device according to claim 2, characterized in that the door is releasable from the frame by means of a manual actuation device independently of said electronic device.

19. Access device according to claim 2, characterized by an acoustic signaling device that signals the admitted passage by a signaling tone.

20. Access device according to claim 2, characterized by an optical signaling device that signals the admitted passage by an optical signal, preferably a light signal.
